(19) United States
(12) Patent Application Publication
(10) Pub. No.: US 2025/0207920 A1
(43) Pub. Date: Jun. 26, 2025

(54) EXTERNAL ENVIRONMENT RECOGNITION DEVICE

(71) Applicant: HITACHI ASTEMO, LTD., Hitachinaka-shi, Ibaraki (JP)

(72) Inventors: Hideyuki KUME, Hitachinaka-shi, Ibaraki (JP); Morihiko SAKANO, Tokyo (JP); Shigenori HAYASE, Hitachinaka-shi, Ibaraki (JP); Tatsuhiko MONJI, Hitachinaka-shi, Ibaraki (JP)

(73) Assignee: HITACHI ASTEMO, LTD., Hitachinaka-shi, Ibaraki (JP)

(21) Appl. No.: 18/847,896

(22) PCT Filed: Apr. 28, 2022
(86) PCT No.: PCT/JP2022/019420

§ 371 Date: Sep. 17, 2024

(51) Int. Cl. G01C 21/30; G01S 13/89; G06F 16/29; G06V 20/58

(52) U.S. Cl. CPC G01C 21/30; G01S 13/89; G06F 16/29; G06V 20/58; G06V 2201/07

(57) ABSTRACT

Provided is an external environment recognition device 1 capable of accurately estimating a relative relationship between a map feature and a target detected by a sensor. The external environment recognition device 1 includes a self-position estimation unit 3 that estimates self-positions 10P1 to 10P4 which are positions of a host vehicle 10 on a map based on external environment information acquired by an external environment sensor 2 mounted on the host vehicle 10, and a target recognition unit 4 that recognizes targets around the host vehicle 10 based on the external environment information. Further, the external environment recognition device 1 includes a map information acquisition unit 5 that acquires map information, which includes a map point group 16G that is a set of feature points on the map and feature information including information on a position and a type of a feature, a sensor point group acquisition unit 6 that acquires a sensor point group 15G around the targets recognized by the target recognition unit 4 from the target recognition unit 4, and a point group matching unit 7 that estimates positions of the targets on the map by matching between the sensor point group 15G acquired by the sensor point group acquisition unit 6 and the map point group 16G.

### TECHNICAL FIELD

The present invention relates to an external environment recognition device mounted on a vehicle.

### BACKGROUND ART

In recent years, a driving assistance device and an automatic driving device of a vehicle have been developed. In the driving assistance device or the automatic driving device, it is important to estimate a position of a target.

PTL 1 describes a technique of detecting a target from two points by using a camera or a sensor mounted on a host vehicle, obtaining two error distributions, and comparing standard errors E1 and E2.

The technique described in PTL 1 is a technique of determining whether or not to select one sampling point of two error distributions or a sampling point of an overlapping region of two error distributions from a magnitude relationship between the standard errors E1 and E2 and estimating the target by using the selected sampling point.

### CITATION LIST

### Patent Literature

PTL 1: JP 2018-185156 A

### SUMMARY OF INVENTION

### Technical Problem

However, PTL 1 does not consider a case where there is an error between a sensor point group detected by using the camera or the sensor and a map point group and has a difficulty to accurately estimate a relative relationship between a map feature and a target by the sensor in a case where there is the error between the sensor point group and the map point group.

When it is difficult to accurately estimate the relative relationship between the map feature and the target detected by the sensor, it is difficult to perform driving assistance and automatic driving of the vehicle with high accuracy.

An object of the present invention is to provide an external environment recognition device and an external environment recognition method capable of accurately estimating a relative relationship between a map feature and a target detected by a sensor.

### Solution to Problem

In order to achieve the above object, the present invention is configured as follows.

An external environment recognition device includes a self-position estimation unit that estimates a self-position which is a position of a host vehicle on a map stored in a map database based on external environment information acquired by an external environment sensor mounted on the host vehicle, a target recognition unit that recognizes targets around the host vehicle based on the external environment information, a map information acquisition unit that acquires map information, which includes a map point group which is a set of feature points on the map and feature information including information on a position and a type of a feature, a sensor point group acquisition unit that acquires a sensor point group around the targets recognized by the target recognition unit from the target recognition unit, and a point group matching unit that estimates positions of the targets on the map by matching between the sensor point group acquired by the sensor point group acquisition unit and the map point group.

In addition, an external environment recognition method includes estimating a self-position which is a position of a host vehicle on a map stored in a map database based on external environment information acquired by an external environment sensor mounted on the host vehicle, recognizing targets around the host vehicle based on the external environment information, acquiring map information, which includes a map point group which is a set of feature points on the map and feature information including information on a position and a type of a feature, acquiring a sensor point group around the recognized targets, and estimating a position of the target on the map by matching between the acquired sensor point group and the map point group.

### Advantageous Effects of Invention

According to the present invention, it is possible to provide the external environment recognition device and the external environment recognition method capable of accurately estimating the relative relationship between the map feature and the target detected by the sensor.

In the present invention, a position of a sensor target on a map is estimated by extracting a point group around a sensor target (a target detected by a sensor) and performing point group matching between a map point group and the sensor target, and a relative relationship between a map feature and a sensor target is accurately estimated.

### BRIEF DESCRIPTION OF DRAWINGS

FIG. 1 is a schematic configuration diagram of an external environment recognition device according to a first embodiment of the present invention.

FIG. 2 is an explanatory diagram of a scale error.

FIG. 3 is an explanatory diagram of the scale error.

FIG. 4 is an explanatory diagram of an angle error.

FIG. 5 is an explanatory diagram of the angle error.

FIG. 6 is an operation explanatory diagram of point group matching according to the first embodiment.

FIG. 7 is a diagram illustrating an information table of an example in which a combination of a sensor target and a map feature is set.

FIG. 8 is an explanatory diagram of selection of the sensor target.

FIG. 9 is a diagram illustrating an information table illustrating a relationship between the sensor target, the map feature, and a threshold value.

FIG. 10 is a schematic configuration diagram of an external environment recognition device according to a second embodiment of the present invention.

FIG. 11 is an operation explanatory diagram of a speed prediction unit.

FIG. 12 is a schematic configuration diagram of an external environment recognition device according to a third embodiment of the present invention.

FIG. 13 is an operation explanatory diagram of an intended speed prediction unit.

FIG. 14 is a schematic configuration diagram of an external environment recognition device according to a fourth embodiment of the present invention.

FIG. 15 is an explanatory diagram illustrating that there is a highly accurate range in an external environment recognition result by a target recognition unit.

FIG. 16 is an explanatory diagram of self-map generation according to the fourth embodiment.

FIG. 17 is a schematic configuration diagram of an external environment recognition device according to a fifth embodiment of the present invention.

FIG. 18 is an operation explanatory diagram of a trajectory prediction unit according to the fifth embodiment.

### DESCRIPTION OF EMBODIMENTS

Embodiments of the present invention will be described in detail with reference to the accompanying drawings.

### EMBODIMENTS

### First Embodiment

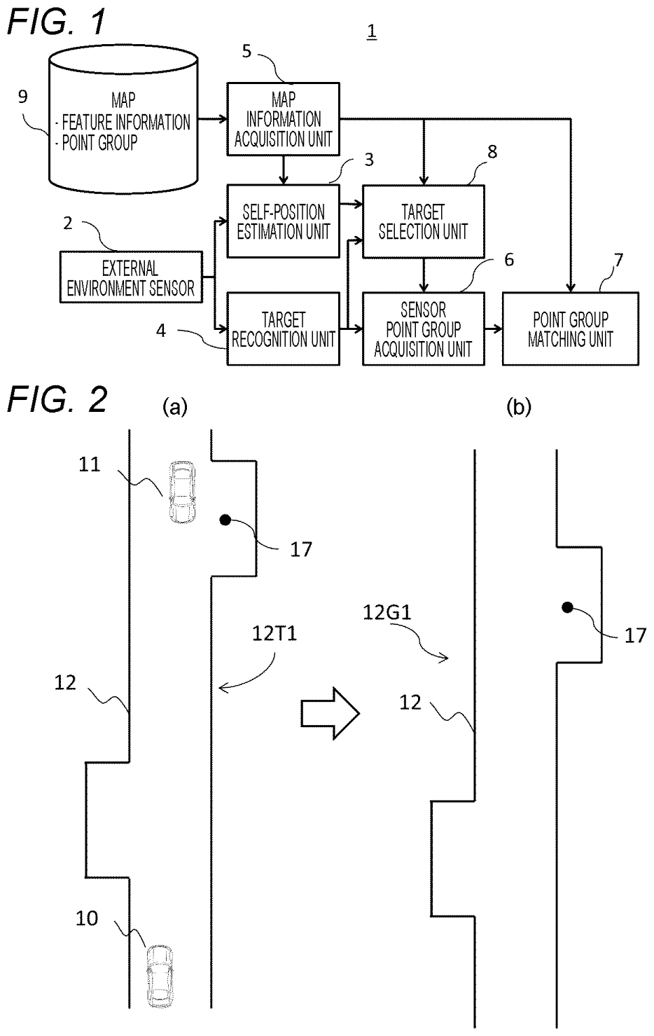

FIG. 1 is a schematic configuration diagram of an external environment recognition device 1 according to a first embodiment of the present invention.

In FIG. 1, the external environment recognition device 1 includes a self-position estimation unit 3, a target recognition unit 4, a map information acquisition unit 5, a sensor point group acquisition unit 6, a point group matching unit 7, and a target selection unit 8.

The self-position estimation unit 3 estimates a self-position, which is a position of a host vehicle 10 on a map based on external environment information acquired by an external environment sensor 2 mounted on the host vehicle 10 (illustrated in FIG. 2).

The target recognition unit 4 recognizes targets around the host vehicle 10 based on external environment information detected by the external environment sensor 2. The external environment sensor 2 is a sensor such as a camera or a radar, and detects external environment information of the host vehicle 10.

The map information acquisition unit 5 acquires map information including map information stored in a storage unit mounted on the host vehicle 10, a map point group which is a set of feature points on a map transmitted from an outside, and feature information including information on a position and a type of a feature. In FIG. 1, the map information is stored in a map database 9. The map database 9 may be stored in the storage unit mounted on the host vehicle 10 or may be information transmitted from the outside.

The sensor point group acquisition unit 6 acquires sensor point groups, which are a plurality of positions around the targets recognized by the target recognition unit 4, from the external environment information detected by the external environment sensor 2.

The point group matching unit 7 estimates positions of the targets on the map recognized by the target recognition unit 4 by matching between the sensor point group acquired by the sensor point group acquisition unit 6 and the map point group acquired by the map information acquisition unit 5. That is, the point group matching unit 7 determines whether or not the point group matching has succeeded, and outputs the positions of the targets on the map estimated by the matching between the sensor point group and the map point group in a case where the point group matching has succeeded. In a case where the point group matching fails, the point group matching unit 7 outputs the positions of the targets on the map calculated by using the self-position and a recognition result of the targets recognized by the target recognition unit 4.

The target selection unit 8 selects a target that satisfies a predetermined condition among targets recognized by target recognition unit 4 based on the self-position of the host vehicle 10 estimated by the self-position estimation unit 3, the recognition result of the targets recognized by target recognition unit 4, and the feature information acquired by the map information acquisition unit 5.

A positional relationship between the host vehicle 10 and a different vehicle 11 and a positional relationship between the host vehicle 10, the different vehicle 11, and a road will be described. With respect to an actual positional relationship (true positional relationship) with a target in an external environment of the host vehicle 10, a positional relationship between a self-generated map by odometry (a method for estimating a current position from a rotation angle of a wheel of the vehicle) and the target in the external environment detected by using the external environment sensor 2 may be inaccurate.

Note that, the different vehicle 11 is also included in the target.

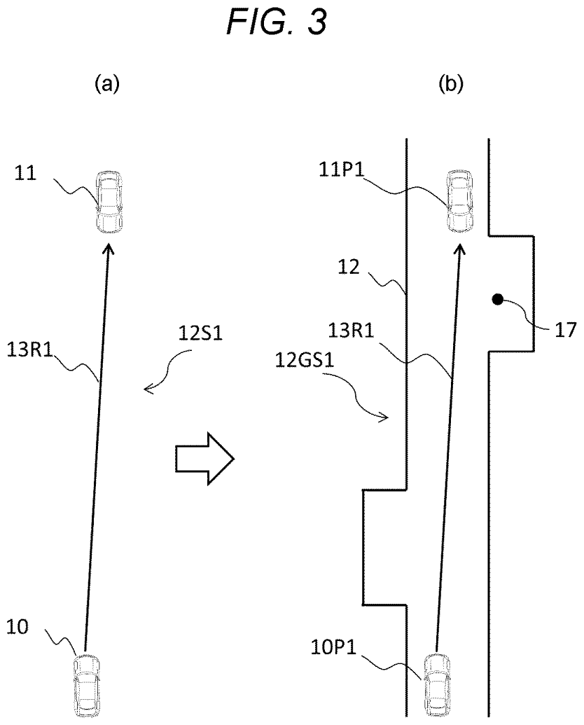

A scale error will be described with reference to FIGS. 2 and 3.

(a) of FIG. 2 is a diagram illustrating a true position map 12T1 which is an actual positional relationship (true positional relationship) with the target in the external environment of the host vehicle 10. In (b) of FIG. 2, the different vehicle 11 is advancing in front of the host vehicle 10 in a direction opposite to an advancing direction of the host vehicle 10. The host vehicle 10 and the different vehicle 11 are traveling within a road boundary 12, and the different vehicle 11 is traveling at a position on the way across a retreat region position 17.

(b) of FIG. 2 is a diagram illustrating a self-generated map 12G1 generated by the host vehicle 10 by using odometry.

Comparing the true position map 12T1 illustrated in (a) of FIG. 2 with the self-generated map 12G1 in (b) of FIG. 2, a position of the retreat region position 17 is shifted. This is because there is a scale error due to an odometry error.

(a) of FIG. 3 is a diagram illustrating a sensing result 12S1 indicating the positional relationship between the host vehicle 10 and the different vehicle 11 detected by using the external environment sensor 2 of the host vehicle 10.

(b) of FIG. 3 is a diagram illustrating a synthesis result map 12GS1 obtained by synthesizing the sensing result 12S1 illustrated in (a) of FIG. 3 and the self-generated map 12G1 illustrated in (b) of FIG. 2.

Comparing the true position map 12T1 illustrated in (a) of FIG. 2 with the composite result map 12G1 illustrated in (b) of FIG. 3, the position of the retreat region position 17 is shifted, and a relative relationship between the different vehicle 11 and the retreat region position 17 is inaccurate.

That is, in the true position map 12T1 illustrated in (a) of FIG. 2, the different vehicle 11 crosses the retreat region position 17, whereas in the synthesis result map 12GS1 illustrated in (b) of FIG. 3, a position 11P1 of the different vehicle is in a state before crossing the retreat region position 17.

When the relative relationship between the different vehicle 11 and the retreat region 17 is inaccurate due to the scale error, it is difficult to perform driving assistance or automatic driving of the host vehicle 10 with high accuracy.

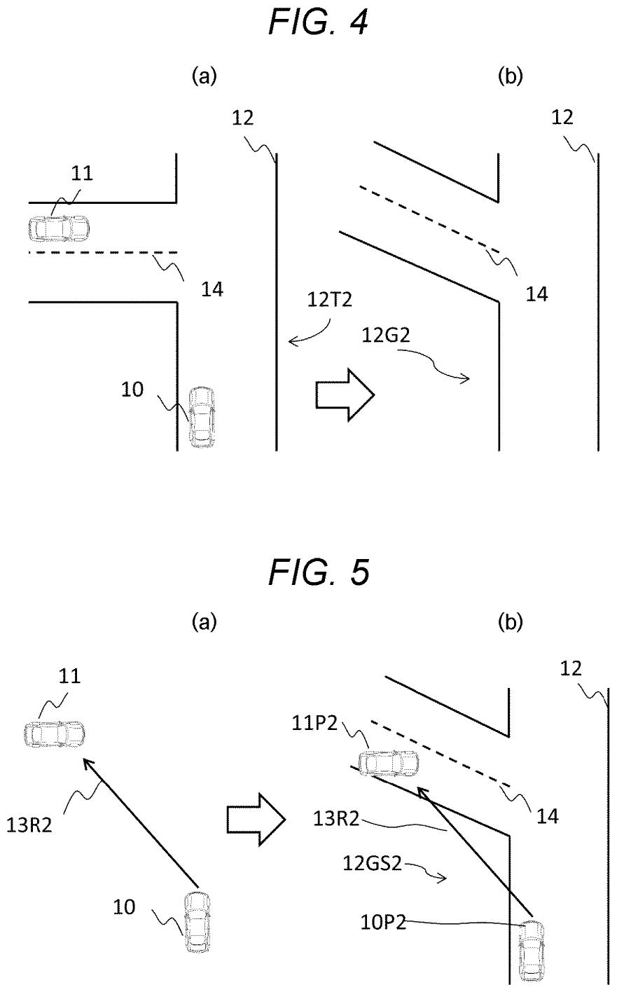

An angle error will be described with reference to FIGS. 4 and 5.

(a) of FIG. 4 is a diagram illustrating a true position map 12T2 which is an actual positional relationship (true positional relationship) with the target in the external environment of the host vehicle 10. In (a) of FIG. 4, the different vehicle 11 is traveling on a road substantially orthogonal to a road on which the host vehicle 10 travels in a direction substantially orthogonal to the advancing direction of the host vehicle 10.

(b) of FIG. 4 is a diagram illustrating a self-generated map 12G2 generated by the host vehicle 10 by using odometry.

Comparing the true position map 12T2 illustrated in (a) of FIG. 4 with the self-generated map 12G2 illustrated in (b) of FIG. 4, an angle of a dividing line 14 is shifted. This is because there is an angle error due to an odometry error.

(a) of FIG. 5 is a diagram illustrating a sensing result 13R2 indicating a positional relationship between the host vehicle 10 and the different vehicle 11 detected by using the external environment sensor 2 of the host vehicle 10.

(b) of FIG. 5 is a diagram illustrating a synthesis result map 12GS2 obtained by synthesizing the sensing result 13R2 illustrated in (a) of FIG. 5 and the self-generated map 12G2 illustrated in (b) of FIG. 4.

Comparing the true position map 12T2 illustrated in (a) of FIG. 4 with the synthesis result map 12GS2 in (b) of FIG. 5, a relative relationship between a different vehicle position 11P2 on the map and the dividing line 14 is inaccurate.

That is, the different vehicle 11 is a position of advancing in a direction parallel to the dividing line 14 in the true position map 12T2 illustrated in (a) of FIG. 4, and the position 11P2 of the different vehicle is a position of advancing in a direction intersecting the dividing line 14 in the synthesis result map 12GS2 illustrated in (b) of FIG. 5.

When the relative relationship between the different vehicle 11 and the dividing line 14 is inaccurate due to the angle error, it is difficult to perform driving assistance or automatic driving of the host vehicle 10 with high accuracy, similarly to the scale error.

In the first embodiment of the present invention, the positions of the targets detected by the external environment sensor 2 on the map are estimated by extracting the point groups around the targets detected by the external environment sensor 2 and performing the point group matching between the extracted point groups around the targets and the map point groups acquired from the map information. Thus, the scale error and the angle error are corrected to accurately estimate the relative relationship between the host vehicle 10, the different vehicle 11, and the feature on the map.

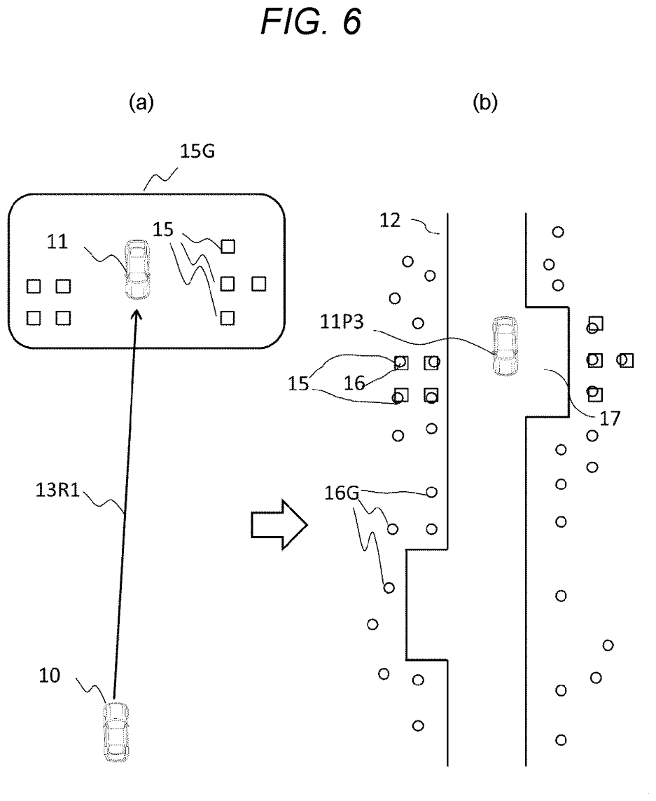

FIG. 6 is an operation explanatory diagram of the point group matching according to the first embodiment of the present invention.

In (a) of FIG. 6, a plurality of points 15 (indicated by squares in FIG. 6) in a sensor point group 15G around the different vehicle 11 are extracted from the external environment information detected by the external environment sensor 2. The sensor point 15 has relatively high accuracy in a region of the sensor point group 15G around the different vehicle 11.

The extraction processing of the plurality of points 15 in the sensor point group 15G is executed by the external environment recognition device 1. That is, the target recognition unit 4 recognizes the targets from the external environment information detected by the external environment sensor 2. In addition, the self-position estimation unit 3 estimates the map information acquired by the map information acquisition unit 5 and the self-position, which is the position of the host vehicle 10 detected by the external environment sensor 2. The target selection unit 8 selects the target from the map information acquired by the map information acquisition unit 5, the self-position estimated by the self-position estimation unit 3, and the targets recognized by the target recognition unit 4. The sensor point group acquisition unit 6 extracts the sensor point group 15G based on the targets recognized by the target recognition unit 4 and the target selected by the target selection unit 8.

Subsequently, the point group matching unit 7 performs matching processing between the sensor points 15 and a map point group 16 based on the map information acquired by the map information acquisition unit 5 and the sensor point group 15G extracted by the sensor point group acquisition unit 6.

(b) of FIG. 6 is an explanatory diagram of the matching processing between the sensor point 15 and the map point 16. Circles in (b) of FIG. 6 indicate the map points 16. A map point group 16G including the map points 16 has relatively high accuracy in a local region.

The matching processing is performed to overlap the sensor points 15 and the map points 16, a relative relationship between a different vehicle position 11P3 on the map and the retreat region 17 is made accurate.

For the angle error illustrated in FIG. 5, the matching processing described above is performed, and thus, the relative relationship between the different vehicle position 11P2 on the map and the dividing line 14 is also made accurate.

The determination of whether or not the matching processing has succeeded in the point group matching unit 7 will be described.

In a case where the number of points included in the map is less than or equal to a predetermined threshold value, it is determined that the matching has failed. In this case, the matching processing is not executed from the beginning.

Subsequently, in a case where the number of points included in the map exceeds the predetermined threshold value, in a case where an average value of distances between the sensor points 15 and the map points 16 corresponding to each other is more than or equal to a predetermined threshold value it is determined that the matching has failed. In addition, in a case where the number of corresponding points between the sensor points 15 and the map points 16 is less than or equal to a predetermined threshold value, it is also determined that the matching has failed.

In a case where the matching processing has succeeded, the point group matching unit 7 outputs a position and a posture of a sensor target on the map estimated by the matching processing. The host vehicle 10 performs driving assistance and automatic driving processing based on the position and posture of the sensor target output from the point group matching unit 7.

In a case where the matching processing has failed, the point group matching unit 7 can output the position and posture of the sensor target on the map (a provisional position of the target selection unit 8) estimated from the self-position estimation result and the sensing result.

Next, an operation of the target selection unit 8 will be described.

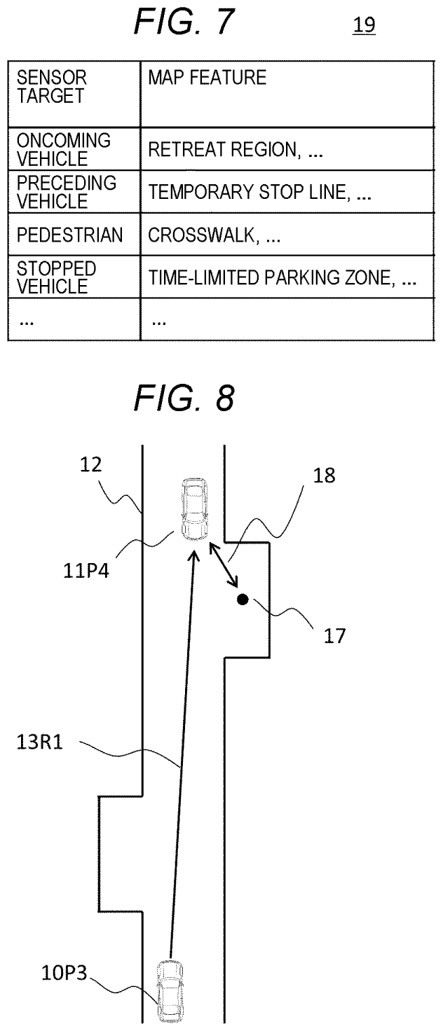

A combination of the sensor target and the map feature whose relative relationship is important is set in advance. FIG. 7 is a diagram illustrating an information table 19 of an example in which the combination of the sensor target and the map feature is set.

FIG. 8 is an explanatory diagram of selection of a sensor target.

The target selection unit 8 calculates a provisional position 11P4 of a sensor feature from a self-position estimation result 10P3 and a sensing result 13R1. The target selection unit 8 selects a sensor target whose distance from a corresponding map feature (a retreat region in the example illustrated in FIG. 8) is less than or equal to a predetermined threshold value.

As illustrated in FIG. 7, the combination of the sensor target and the map feature whose relative relationship is important is set in advance, and the combination of the sensor target and the map feature whose relative relationship is important for the distance between the feature and the sensor target is set in advance. As a result, a processing time for target selection can be shortened.

The target selection unit 8 may be configured to be able to change the threshold value of target selection (the distance between the feature and the sensor target) in accordance with a size, a speed, weather, and brightness of the sensor target such that the target can be appropriately selected.

For example, as the size of the sensor target is larger, the threshold value is set to be larger. As the speed of the sensor target is higher, the threshold value is set to be larger (an arrival time of the sensor target at the map feature can be used instead of the distance).

In addition, as the weather is worse, the threshold value can be set to be larger. As the brightness is darker, the threshold value can be set to be larger.

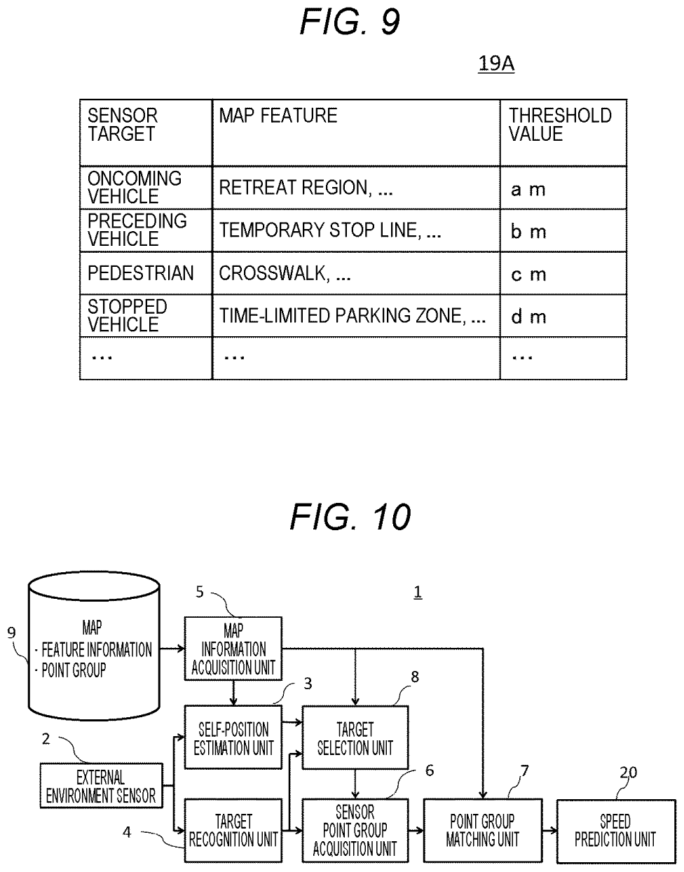

FIG. 9 is a diagram illustrating an information table 19A of an example in which threshold values are added to and retained for the sensor target and the map feature in the information table 19 and a relationship between the sensor target, the map feature, and the threshold values is illustrated. Predetermined threshold values am, bm, cm, dm can be changed in accordance with at least one of the size, speed, weather, and brightness of the sensor target.

An external environment recognition method according to the first embodiment of the present invention will be described.

The self-position that is the position of the host vehicle 10 on the map stored in the map database 9 is estimated based on the external environment information acquired by the external environment sensor 2 mounted on the host vehicle 10, the target around the host vehicle 10 is recognized based on the external environment information, the map information including the map point group that is the set of feature points on the map and the feature information including the information on the position and type of the feature is acquired, the sensor point group around the recognized target is acquired, and the position of the target on the map is estimated by matching the acquired sensor point group and the map point group.

As described above, according to the first embodiment of the present invention, since the position of the sensor target on the map is estimated by extracting the point group around the sensor target and performing the point group matching between the map point group and the sensor target, it is possible to provide the external environment recognition device and the external environment recognition method capable of accurately estimating the relative relationship between the map feature and the target detected by the sensor.

### Second Embodiment

Next, a second embodiment of the present invention will be described.

FIG. 10 is a schematic configuration diagram of an external environment recognition device 1 according to the second embodiment of the present invention. A difference between the second embodiment and the first embodiment illustrated in FIG. 1 is that a speed prediction unit 20 is connected to the point group matching unit 7 of the first embodiment. Other configurations of the second embodiment are similar to the configurations of the first embodiment.

The speed prediction unit 20 predicts a position and a speed of a different vehicle 11 ahead on a map estimated by a point group matching unit 7, is used for an adaptive cruise control (ACC) function, and appropriately controls a speed of the host vehicle 10.

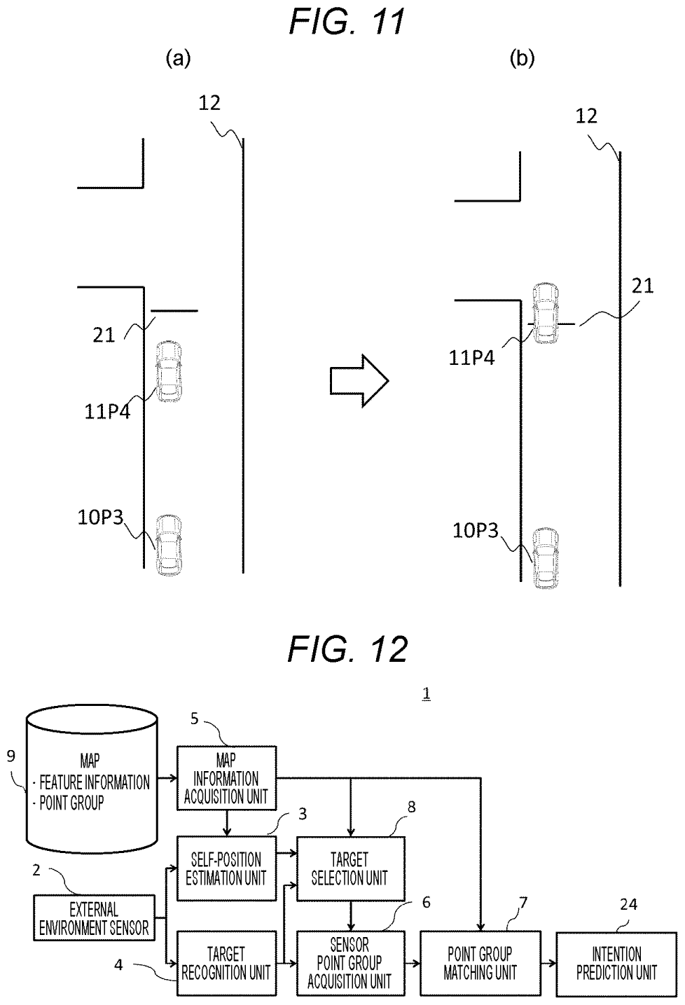

FIG. 11 is an operation explanatory diagram of the speed prediction unit 20.

In (a) of FIG. 11, a host vehicle 10P3 automatically travels at a constant speed while maintaining a constant inter-vehicle distance by an adaptive cruise control function with respect to a different vehicle 11P4 traveling ahead. The speed prediction unit 20 can predict that a speed of the different vehicle 11P4 decreases when the different vehicle 11P4 traveling ahead is approaching a temporary stop line 21.

When a speed of the host vehicle 10P3 is controlled based on the speed prediction of the speed prediction unit 20, the adaptive cruise control function can be executed with high accuracy.

As described above, according to the second embodiment of the present invention, effects similar to the effects of the first embodiment can be obtained, and the adaptive cruise control function can be executed with high accuracy.

### Third Embodiment

Next, a third embodiment of the present invention will be described.

FIG. 12 is a schematic configuration diagram of an external environment recognition device 1 according to the third embodiment of the present invention. A difference between the third embodiment and the first embodiment illustrated in FIG. 1 is that an intention prediction unit 24 is connected to the point group matching unit 7 of the first embodiment. Other configurations of the third embodiment are similar to the configurations of the first embodiment.

The intention prediction unit 24 is used in an automatic driving device, and predicts an intention of a pedestrian based on a relative relationship between a pedestrian position on the map estimated by a point group matching unit 7 and a crosswalk on the map.

As a result, it is possible to accurately predict the intention of the pedestrian and appropriately plan an action of a host vehicle 10.

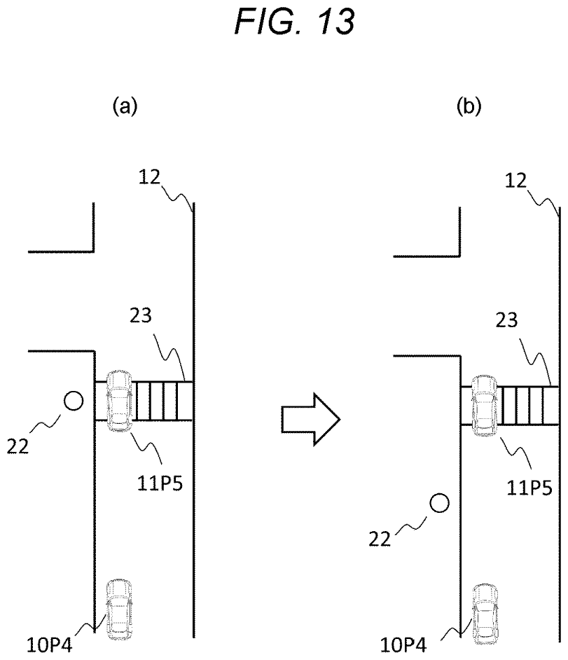

FIG. 13 is an operation explanatory diagram of the intended speed prediction unit 20.

In (a) of FIG. 13, a different vehicle 11P5 in front of a host vehicle 10P4 is positioned on a crosswalk 23, and a pedestrian 22 on a map estimated by point group matching is positioned in front of the crosswalk 23. In this case, the intention prediction unit 24 predicts an intention of the pedestrian 22 to cross the crosswalk 23. Based on the prediction of the intention prediction unit 24, the automatic driving device (not illustrated) can perform control such that the host vehicle 10P4 stops in front of the crosswalk.

In (b) of FIG. 13, the different vehicle 11P5 in front of the host vehicle 10P4 is positioned on the crosswalk 23, and the pedestrian 22 on the map estimated by the point group matching is positioned not in front of the crosswalk 23 but substantially in the middle between the host vehicle 10P4 separated from the crosswalk 23 and the crosswalk 23. In this case, the intention prediction unit 24 predicts that the pedestrian 22 is stopping, and the automatic driving device (not illustrated) can perform control such that the host vehicle 10P4 travels without stopping in front of the crosswalk based on the prediction of the intention prediction unit 24.

Similarly, for a stopped vehicle that is a sensor target and a time-limited parking zone that is a map feature, the intention prediction unit 24 predicts an intention of the stopped vehicle or the like, and the automatic driving device can perform control based on the result. For example, the intention prediction unit 24 predicts whether the stopped vehicle is a parked vehicle or a vehicle that is temporarily stopped at a traffic light or the like.

In a case where the different vehicle 11P5 is positioned on the crosswalk 23, an external environment sensor 2 may not be able to detect the crosswalk 23. In this case, it is necessary to acquire information of a map database 9 and determine whether or not the crosswalk on which the vehicle is positioned is the crosswalk 23.

The intention prediction unit 24 can accurately predict the intention of the pedestrian 22 based on the relative relationship between the position of the pedestrian 22 on the map estimated by the point group matching unit 7 and the crosswalk 23 on the map.

As described above, according to the third embodiment of the present invention, it is possible to obtain effects similar to the effects of the first embodiment, and it is possible to appropriately control the host vehicle 10 by automatic driving by predicting the intention of the pedestrian or the like.

### Fourth Embodiment

Next, a fourth embodiment of the present invention will be described.

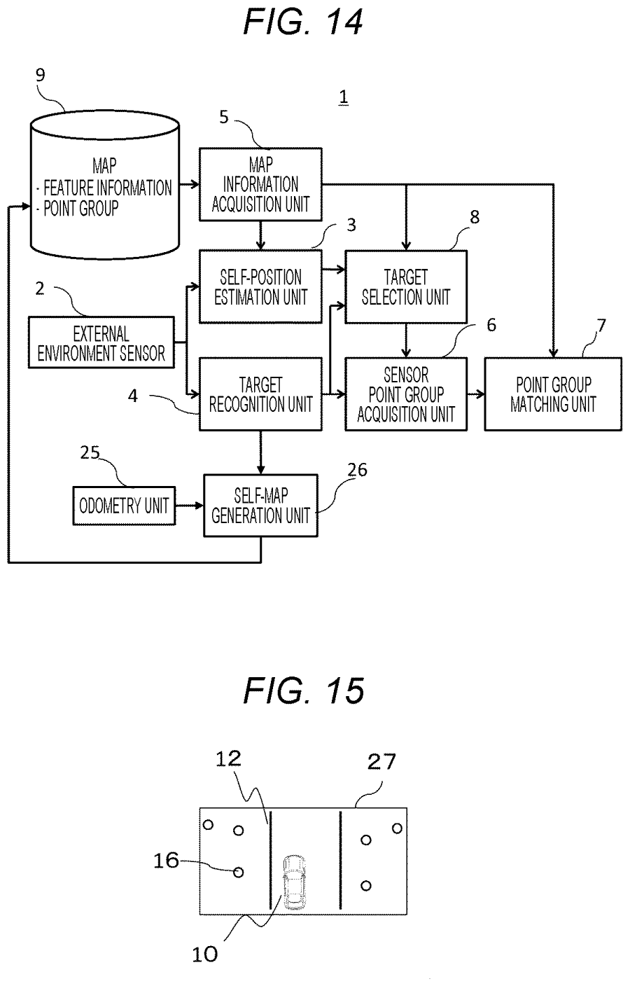

FIG. 14 is a schematic configuration diagram of an external environment recognition device 1 according to the fourth embodiment of the present invention. A difference between the fourth embodiment and the first embodiment illustrated in FIG. 1 is that a self-map generation unit 26 is connected to the target recognition unit 4 of the first embodiment and the self-map generation unit 26 generates a self-map from information from an odometry unit 25 and target information from a target recognition unit 4 and stores the self-map in a map database 9. Other configurations of the fourth embodiment are similar to the configurations of the first embodiment.

As illustrated in FIG. 15, in the fourth embodiment, in a case where there is a highly accurate range 27 in an external environment recognition result by the target recognition unit 4 at each moment, the map by the odometry unit 25 and the information by the target recognition unit 4 are fused with respect to the range 27 to generate the self-map.

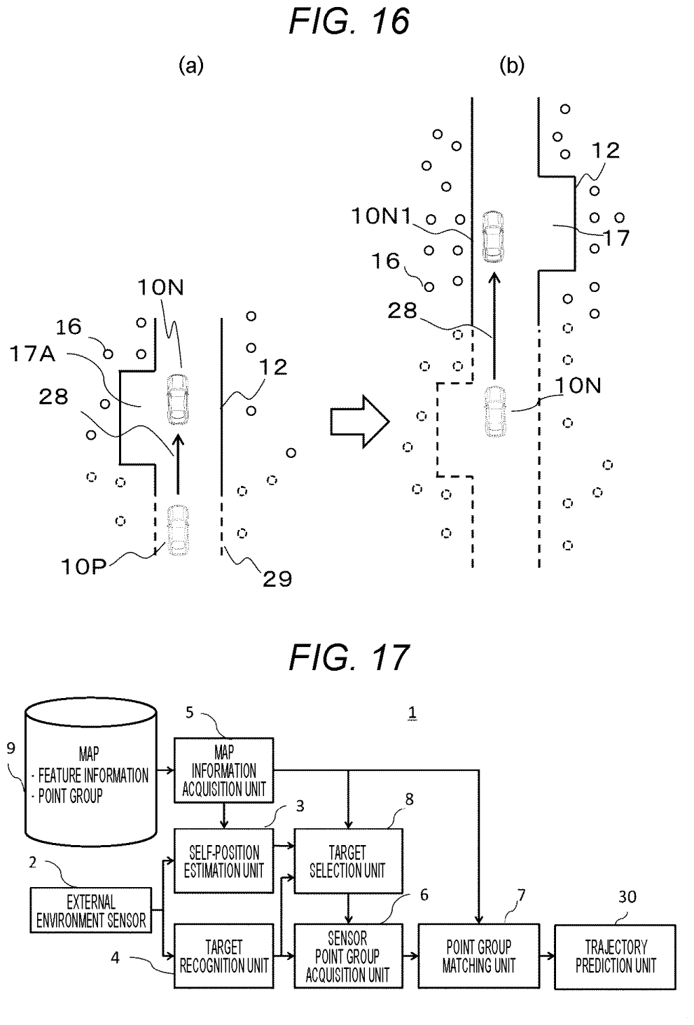

As illustrated in (a) of FIG. 16, since an external environment recognition result 29 of a host vehicle 10P in an external environment recognition result 29 before one moment is not in the highly accurate range, the map is not generated by the self-map generation unit 26.

Since a retreat region 17A in a host vehicle 10N at a subsequent moment is in the highly accurate range, the self-map generation unit 26 generates the self-map from an odometry estimated position 28 and the target information from the target recognition unit 4, and stores the self-map in the map database 9.

A state where a time has further elapsed from the state illustrated in FIG. 16(a) is the state illustrated in of FIG. 16(b). Since a retreat region 17 near a host vehicle 10N1 in the state illustrated in (b) of FIG. 16 is a highly accurate range, the self-map generation unit 26 generates the self-map from the odometry estimated position 28 and the target information from the target recognition unit 4 and stores the self-map in the map database 9. The self-map generation unit 26 stores a sensor point group 15G as a map around a feature described in an information table 19 in which a type of the target and a type of the feature are associated with each other.

In this manner, a relatively highly accurate map is generated and stored in the map database 9.

In the example described above, although the relatively highly accurate map is generated and stored in the map database 9, it is also possible to store a point group only around a map feature whose relative positional relationship with the sensor target is important. For example, it is also possible to store the point group only around the retreat region. By doing this, a map capacity stored in the map database 9 can be reduced.

As described above, according to the fourth embodiment of the present invention, it is possible to obtain effects similar to the effects of the first embodiment, generate a relatively highly accurate map, and further reduce the map capacity stored in the map database 9.

### Fifth Embodiment

Next, a fifth embodiment of the present invention will be described.

FIG. 17 is a schematic configuration diagram of an external environment recognition device 1 according to a fifth embodiment of the present invention. A difference between the fifth embodiment and the first embodiment illustrated in FIG. 1 is that a trajectory prediction unit 30 is connected to the point group matching unit 7 of the first embodiment. Other configurations of the fifth embodiment are similar to the configurations of the first embodiment.

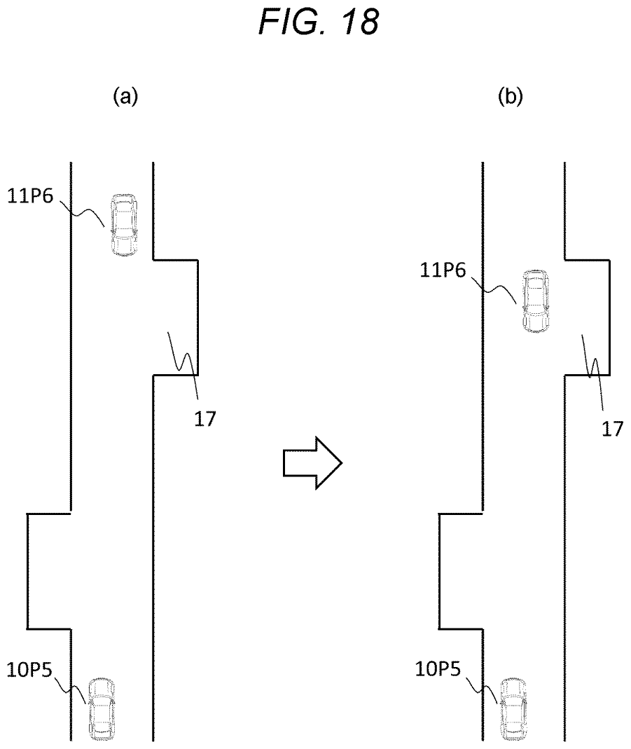

As illustrated in (a) and (b) of FIG. 18, the trajectory prediction unit 30 predicts a trajectory of an oncoming vehicle 11P6 based on a relative relationship between the oncoming vehicle position 11P6 on a map estimated by the point group matching unit 7 and a retreat region 17 on the map.

In the state illustrated in (a) of FIG. 18, the trajectory prediction unit 30 predicts that the oncoming vehicle may enter the retreat region 17. In the state illustrated in (b) of FIG. 18, the trajectory prediction unit 30 predicts that the oncoming vehicle does not enter the retreat region 17.

Since the trajectory prediction unit 30 can accurately predict the trajectory of the oncoming vehicle, an action of the host vehicle can be appropriately planned.

As described above, according to the fifth embodiment of the present invention, since effects similar to the effects of the first embodiment can be obtained and the trajectory of the oncoming vehicle can be accurately predicted, the action of the host vehicle can be appropriately planned.

Note that, in the first to fifth embodiments described above, although a target selection unit 8 is a constituent requirement of the external environment recognition device 1, the article selection unit 8 can be omitted, and an example in which the article selection unit 8 is omitted is also included in the embodiment of the present invention.

In the example in which the article selection unit 8 is omitted, a self-position estimated by a self-position estimation unit 3 is output to the point group matching unit 7, and target information recognized by a target recognition unit 4 is output only to a sensor point group acquisition unit 6. Then, the point group matching unit 7 performs point group matching based on the self-position estimated by the self-position estimation unit 3, the sensor point group acquired by the sensor point group acquisition unit 6, and map information from a map information acquisition unit 5.

### REFERENCE SIGNS LIST

1 appearance recognition device
2 external environment sensor
3 self-position estimation unit
4 target recognition unit
5 map information acquisition unit
6 sensor point group acquisition unit
7 point group matching unit
8 target selection unit
9 map database
10 host vehicle
10P1, 10P2, 10P3, 10P4, 10P5 host vehicle position on map
11 different vehicle
11P1, 11P2, 11P3, 11P4, 11P5, 11P6 different vehicle position on map
11P4 provisional different vehicle position
12 road boundary
12G1, 12G2 self-generated map
12GS1, 12GS2 map sensing synthesis result state
12S1 sensing result state
12T1, 12T2 true state
13R1, 13R2 relative position of host vehicle to different vehicle
14 dividing line
15 extracted point
15G extracted point group
16 map point
17, 17A retreat region position
18TH threshold value distance
19, 19A information table
20 speed prediction unit
21 temporary stop line
22 pedestrian position
23 crosswalk
24 intention prediction unit
25 odometry unit
26 self-map generation unit
27 good accuracy range
28 odometry estimated position
29 external environment recognition result before one moment
30 trajectory prediction unit

1. An external environment recognition device, comprising:
a self-position estimation unit that estimates a self-position which is a position of a host vehicle on a map stored in a map database based on external environment information acquired by an external environment sensor mounted on the host vehicle;
a target recognition unit that recognizes targets around the host vehicle based on the external environment information;
a map information acquisition unit that acquires map information, which includes a map point group which is a set of feature points on the map and feature information including information on a position and a type of a feature;
a sensor point group acquisition unit that acquires a sensor point group around the targets recognized by the target recognition unit from the target recognition unit; and
a point group matching unit that estimates positions of the targets on the map by matching between the sensor point group acquired by the sensor point group acquisition unit and the map point group.

2. The external environment recognition device according to claim 1, further comprising:
a target selection unit that selects the target satisfying a predetermined condition among the targets recognized by the target recognition unit based on the self-position estimated by the self-position estimation unit, a recognition result of the targets recognized by the target recognition unit, and the feature information,
wherein the sensor point group acquisition unit acquires a sensor point group around the selected target from the target recognition unit.

3. The external environment recognition device according to claim 2, wherein the target selection unit selects the target in a case where there is the corresponding feature around the targets recognized by the target recognition unit while referring to an information table in which a type of the target and the type of the feature are associated with each other.

4. The external environment recognition device according to claim 3,
wherein the target selection unit estimates a provisional position of the target on the map by using the self-position and the recognition result of the targets recognized by the target recognition unit, and
selects the target in a case where a distance between the provisional position and a position of the feature corresponding to the target in the information table is less than or equal to a threshold value.

5. The external environment recognition device according to claim 4,
wherein the information table retains a threshold value used by the target selection unit for each association of the type of the target with the type of the feature, and
the target selection unit changes the threshold value retained in the information table based on at least one of the recognition result of the targets, weather, and brightness.

6. The external environment recognition device according to claim 1, wherein the point group matching unit determines whether or not point group matching has succeeded, and outputs a position of the target on the map estimated by the matching between the sensor point group and the map point group in a case where the point group matching has succeeded.

7. The external environment recognition device according to claim 1, wherein the point group matching unit determines whether or not point group matching has succeeded, and outputs a position of the target on the map calculated by using the self-position and a recognition result of the targets recognized by the target recognition unit in a case where the point group matching has failed.

8. The external environment recognition device according to claim 1, further comprising:
a prediction unit that predicts at least one of a trajectory, a speed, and an intention of the target based on a position of the target on the map estimated by the point group matching unit and a position of the feature on the map.

9. The external environment recognition device according to claim 1, further comprising a self-map generation unit that generates the map by using relative position and posture of the host vehicle estimated by odometry, a recognition result of the targets recognized by the target recognition unit, and the sensor point group.

10. The external environment recognition device according to claim 9, wherein the self-map generation unit stores the sensor point group as the map in the map database around the feature described in an information table in which a type of the target and the type of the feature are associated with each other.

11. An external environment recognition method, comprising:
estimating a self-position which is a position of a host vehicle on a map stored in a map database based on external environment information acquired by an external environment sensor mounted on the host vehicle;
recognizing targets around the host vehicle based on the external environment information;
acquiring map information, which includes a map point group which is a set of feature points on the map and feature information including information on a position and a type of a feature;
acquiring a sensor point group around the recognized targets; and
estimating a position of the target on the map by matching between the acquired sensor point group and the map point group.

12. The external environment recognition method according to claim 11, further comprising:
selecting the target satisfying a predetermined condition among the recognized targets based on the estimated self-position, a recognition result of the recognized targets, and the feature information; and
acquiring a sensor point group around the selected target.
